(19) United States
(12) Patent Application Publication
(10) Pub. No.: US 2008/0307423 A1
(43) Pub. Date: Dec. 11, 2008

(54) Schedule Based Cache/Memory Power Minimization Technique

(75) Inventor: Sainath Karlapalem, Bangalore (IN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/158,806

(22) PCT Filed: Dec. 20, 2006
(86) PCT No.: PCT/IB06/54965

§ 371 Date: Jun. 23, 2008

Related U.S. Application Data
(60) Provisional application No. 60/752,856, filed on Dec. 21, 2005.

(51) Int. Cl. G06F 1/32; G06F 12/08; G06F 9/46

(52) U.S. Cl. 718/102; 711/118; 713/320; 711/E12.041

(57) ABSTRACT

A system includes a task scheduler (301) comprising a task execution schedule (101) for a plurality of tasks to be executed on a plurality of cache lines in a cache memory. The system also includes a cache controller logic (303) having a voltage scalar register (305). The voltage scalar register (305) is updated by the task scheduler with a task identifier (204) of a next task to be executed. The system has a voltage scalar (304), wherein the voltage scalar (304) selects one or more cache lines to operate in a low power mode based on the task execution schedule (101). The task execution schedule (101) is stored in a look up table.

The present invention relates to cache memory, and more particularly to the power minimization in cache memory.

Cache/memory power has become an important parameter for the optimization in the system design process, especially for portable devices such as personal digital assistants (PDA), mobile phones, etc. Various techniques are known in used in the art to manage power consumption by cache/memory subsystems, both from a hardware and software perspective. For example, a Drowsy cache technique exploits the activity of cache lines to minimize the leakage power by pushing cold cache lines to drowsy mode. For another example, existing software based techniques targeted towards cache/memory power minimization uses frequency of access of cache blocks to determine which cache blocks are put to sleep. However, these techniques are less than optimal.

Accordingly, there exists a need for an improved method and system for cache/memory power minimization. The method and system should use task schedule information in selecting particular cache lines to operate in low power mode. The present invention addresses such a need.

The method and system uses task schedule information in selecting particular cache lines to operate in low power mode. In a multi-tasking scenario, where multiple tasks or threads are scheduled on a single processor, the processor stores multiple contexts corresponding to different tasks and may switch from one task to another in a task block. In this scenario, the cache contains the data corresponding to different tasks, over a period of an application run, in the form of a task schedule. With the present invention, voltage scale down is done for select cache lines based on the task schedule. The task schedule is stored by a task scheduler in the form of a look up table. A cache controller logic includes: a voltage scalar register, which is updated by the task scheduler with a task identifier of a next task to be executed: and a voltage scalar, which selects one or more cache lines to operate in a low power mode based on the task execution schedule.

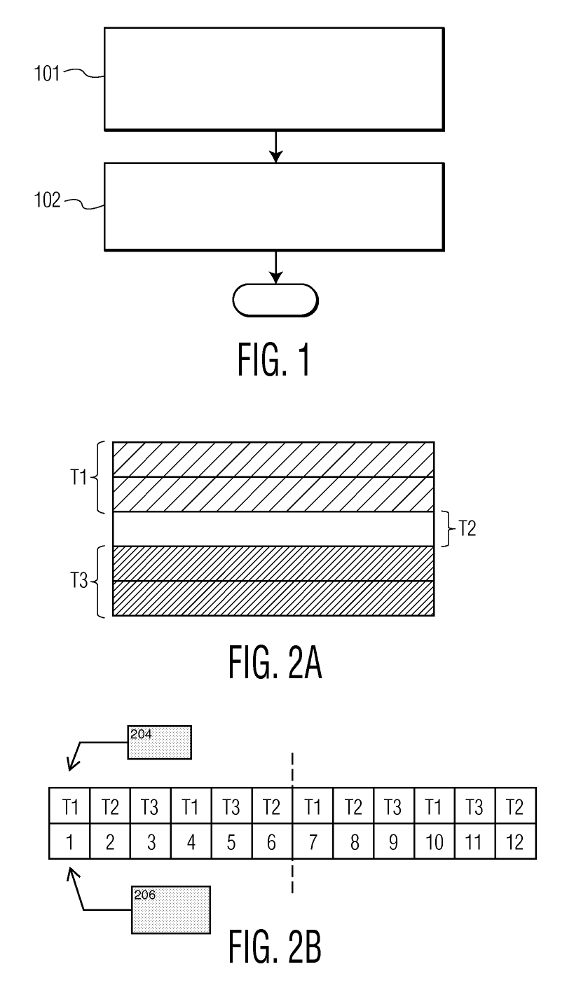

FIG. 1 is a flowchart illustrating an embodiment of a method for using task schedule information in selecting particular cache lines to operate in low power mode in accordance with the present invention.

FIGS. 2A and 2B illustrate example task schedules and cache lines.

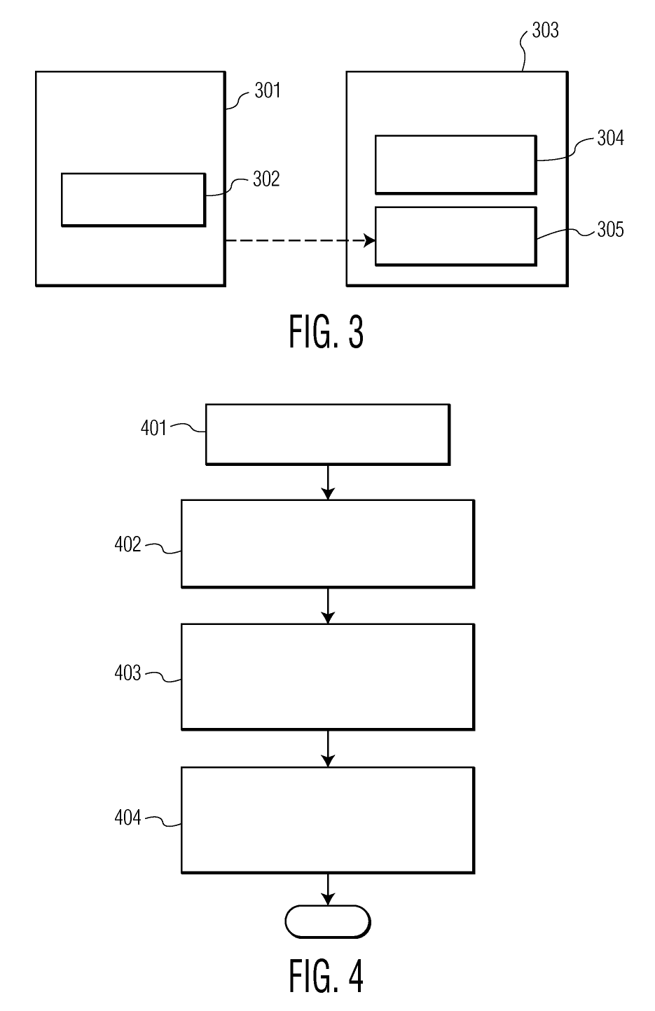

FIG. 3 illustrates an embodiment of a system for using task schedule information in selecting particular cache lines to operate in low power mode in accordance with the present invention.

FIG. 4 is a flowchart illustrating the method in accordance with the present invention as implemented by the system of FIG. 3.

The method and system in accordance with the present invention use task schedule information in selecting particular cache lines to operate in low power mode. In a multi-tasking scenario, where multiple tasks or threads are scheduled on a single processor, the processor stores multiple contexts corresponding to different tasks and may switch from one task to another in a task block. In this scenario, the cache contains the data corresponding to different tasks, over a period of an application run, in the form of a task schedule. With the present invention, voltage scale down is done for select cache lines based on the task schedule.

FIG. 1 is a flowchart illustrating an embodiment of a method for using task schedule information in selecting particular cache lines to operate in low power mode in accordance with the present invention. First, a task execution schedule is determined for a plurality of tasks to be executed on a plurality of cache lines in the cache memory, via step 101. Then, one or more cache lines are operated in a low power mode based on the task execution schedule, via step 102.

For example, consider three tasks T1, T2, and T3, illustrated in FIGS. 2A and 2B. These tasks are mapped on a processor, and each task fills up different cache blocks during their execution. In the illustrated scenario, where different cache blocks are allocated to different tasks, the present invention uses the task schedule information to determine which particular cache line to dynamically operate in low power mode. For example, consider the task schedule illustrated in FIG. 2B, where the tasks follow a particular order, a common scenario in the streaming application domain. The top row indicates the task identifiers (ID's), and the bottom row indicates the schedule instance. From the above sequence, it can be seen that the schedule follows a recurring pattern (T1, T2, T3, T1, T3, T2).

According to one embodiment, a task scheduler is able to determine the task execution schedule (step 101) since it stores this schedule information dynamically in a look up table. Assume that the power minimization policy considers the task which will be scheduled farther in time with respect to a current execution instant, and selects cache lines corresponding to that particular task for dynamic voltage scale down (step 102). This allows the corresponding cache lines to operate in low power mode.

This tasks schedule based technique in accordance with the present invention is advantageous over known techniques, such as the Least Recently Used (LRU) techniques. Considering the task schedule in FIG. 2B, the LRU technique selects cache lines corresponding to task T1 to replace when the processor executes task T3 (running during schedule instance 3), because at the time the processor is executing task T3, the cache lines corresponding to task T1 will be the least recently used. However, with the LRU technique, the next runnable task is T1 (schedule instance 4), and hence the processor experiences an immediate switch over to high voltage levels for those cache lines corresponding to task T1. In contrast, with the task schedule based technique in accordance with the present invention, the task scheduler would determine that the next runnable task is T1, and hence chooses task T2's cache lines to operate in low power mode during the execution of task T3. The immediate switch over to high voltage levels is avoided.

FIG. 3 illustrates an embodiment of a system for using task schedule information in selecting particular cache lines to operate in low power mode in accordance with the present invention. The system includes a task scheduler 301, which stores the task schedule pattern in the form of a look up table (LUT) 302. The system further includes a cache controller logic 303, which includes a voltage scalar 304 and a voltage scalar register 305. The voltage scalar register specifies the task ID and is updated by the task scheduler 301. The voltage scalar 304 chooses the cache lines corresponding to a particular task for voltage scale down. In one embodiment, any addressable register can be used as the voltage scalar register, as long as the register can be part of an MMIO space and the task scheduler can write information to it.

FIG. 4 is a flowchart illustrating the method in accordance with the present invention as implemented by the system of FIG. 3. First, the task scheduler 301 stores the task pattern in the LUT 302, via step 401. The task scheduler 301 updates the voltage scalar register 305 with the task ID of the next runnable task, via step 402. The voltage scalar 304 reads the task ID in the voltage scalar register 305 and compares it with task IDs of cache block tags, via step 403. The voltage scalar 304 then selects a cache block for voltage scaling based on cache power minimization policies, via step 404. The steps of FIG. 4 can be iteratively applied to the list of tasks in the task schedule.

The method in accordance with the present invention can be deployed along with any cache power minimization policy. For example, if there is no cache line corresponding to the next runnable task, then cache lines selection for voltage scaling can be according to conventional policies. The LRU techniques are another example. The present invention can also be easily applied to multiprocessor systems-on-a-chip (SoCs).

The method and system in accordance with the present invention are useful for multi-tasking in streaming (audio/video) applications, where there is a periodic pattern with respect to the scheduling of tasks. Such applications may implement various video compression standards, such as the H.264 video compression standard. The H.264 video compression standard yield better picture quality than previous video compression standards, while significantly lowering the bit rate. It enhances the ability to predict the values of the content of a picture to be encoded, as well as other improved coding efficiencies. Robustness to data errors/losses and flexibility for operation over a variety of network environments is enabled by the standard as well. This standard allows lower overall system cost, reduced infrastructure requirements and enables many new video applications.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

1. A method for managing power consumption in a cache memory, comprising the steps of: determining a task execution schedule for a plurality of tasks to be executed on a plurality of cache lines in the cache memory; and operating one or more cache lines in a low power mode based on the task execution schedule.

2. The method of claim 1, wherein the task execution schedule comprises: task identifiers for the plurality of tasks; and schedule instances of the plurality of tasks.

3. The method of claim 1, wherein the operating step comprises: selecting the cache lines to operate in low power mode based on power minimization policies.

4. The method of claim 3, wherein each task is allocated to a cache line, and the power minimization policies comprises voltage scale down of cache lines for tasks farther in time with respect to a current execution instant.

5. A system, comprising: a task scheduler comprising a task execution schedule for a plurality of tasks to be executed on a plurality of cache lines in a cache memory; and a cache controller logic comprising: a voltage scalar register, wherein the voltage scalar register is updated by the task scheduler with a task identifier of a next task to be executed, and a voltage scalar, wherein the voltage scalar selects one or more cache lines to operate in a low power mode based on the task execution schedule.

6. The system of claim 5, wherein the task execution schedule is stored in a look up table.

7. The system of claim 5, wherein the task execution schedule comprises: task identifiers for the plurality of tasks; and schedule instances of the plurality of tasks.

8. The system of claim 5, wherein the voltage scalar selects the cache lines to operate in a low power mode based on power minimization policies.

9. The system of claim 8, wherein each task is allocated to a cache line, wherein the power minimization policies comprises voltage scale down of cache lines for tasks farther in time with respect to a current execution instant.
